(19) United States
(12) Patent Application Publication
(10) Pub. No.: US 2008/0168837 A1
(43) Pub. Date: Jul. 17, 2008

(54) LIQUID SURFACE DETECTING DEVICE

(75) Inventor: Yasuaki OKADA, Toyohashi (JP)

Correspondence Address: STEVENS DAVIS LLP, 1615 L STREET NW, SUITE 850, WASHINGTON, DC, 20036, US

(73) Assignee: AISAN KOGYO KABUSHIKI KAISHA, Aichi-ken (JP)

(21) Appl. No.: 11/970,720

(22) Filed: Jan. 8, 2008

(30) Foreign Application Priority Data
Jan. 15, 2007 (JP) 2007-005696

(51) Int. Cl. G01F 23/32

(52) U.S. Cl. 73/317

(57) ABSTRACT

In a liquid surface detecting device including a movable unit having an arm and a float, for detecting a liquid surface in response to a positional variation of the float, a liquid-repellent coating is formed on the surface of at least one of the arm and the float. Accordingly, it is possible to improve degree of precision of detecting the liquid surface since the movable unit such as the float is restrained from being displaced in response to a temporary displacement of the liquid surface in a fuel tank which is caused when a vehicle oscillates.

### FIELD OF THE INVENTION

The present invention relates to a liquid surface detecting device.

### DESCRIPTION OF THE RELATED ART

Heretofore, there was known a liquid surface detecting device 101 as disclosed in JP-A-2002-202179, as shown in FIGS. 4 and 5.

The liquid surface detecting device 101 is incorporated in a fuel tank 102 which is installed on an automobile, and which is filled therein with a liquid fuel such as gasoline.

As shown in FIG. 4, the liquid surface detecting device 101 includes a support plate 103 which is arranged at the inner wall of the fuel tank 102 in the vicinity of an opening of the fuel tank 102. An insulation substrate 105 is attached on a surface of the support plate 103.

Further, as shown in FIG. 5, the insulation substrate 105 includes a resistance layer 107, a plurality of electrodes 108 and a sliding ruler 110. The resistance layer 107 is provided on a surface of the insulation substrate 105, and the electrodes 108 are extended on the surface of the insulation substrate 105 from the lower end part, as viewed in FIG. 5, of the resistance layer 107, in parallel therewith.

The sliding ruler 110 includes a longitudinal conductive contact plate 112 and a cylindrical contact point 113. The contact plate 112 is supported by the support plate 103 so as to rotate about a rotation base 114. The contact point 113 is attached to the distal end of the contact plate 112, being opposed to the electrodes 108 and being slidable on the electrodes 108. The contact plate 112 serves as a negative terminal of the liquid surface detecting device 101, and a right end portion 116, as viewed in FIG. 5, of the resistance layer 107 serves as a positive terminal of the liquid surface detecting device 101.

An arm 120 is fixed at one end portion to the rotation base 114 of the contact plate 112, and is adapted to rotate together with the contact plate 112 about the rotation base 114. As shown in FIG. 4, a float 122 is connected to the other end portion of the arm 120 so as to be rotatable relative thereto. The float 122 is configured to float on a liquid surface of a gasoline etc., in the fuel tank 102 and to be displaced vertically in the fuel tank 102 in response to a displacement of the liquid surface of the gasoline etc. Further, the arm 120 rotates about the rotation base 114 in response to a displacement of the float 122, and as a result, the contact point 113 of the sliding ruler 110 is turned about the rotation base 114 as a rotating center so that the contact point 113 is displaced sliding on the surface of each electrode 108. Accordingly, it is possible to detect a height of the liquid surface of the gasoline, that is, a quantity of the gasoline contained in the fuel tank 102, being based on a resistance value of a resistance part in the resistance layer 107 extended between one of the electrodes 108 which is determined by the sliding amount of the contact point 113, and the right end part 116 of the resistance layer 107.

The known arm 120 and the float 122 are formed of a metal or resin, the material thereof being bared with no surface treatment thereto. Accordingly, the arm 120 and the float 122 may have much wettability with liquid fuel such as gasoline, and accordingly, the float 122 is displaced readily following up temporary displacement of the liquid surface caused by swinging of the automobile, resulting in a problem of lowering of the accuracy of detection of the liquid surface.

Moreover, since the float 122 is displaced following up even a temporary displacement of the liquid surface, there would be a risk of wearing of a part of the electrode 108 which is made into contact with the contact point 113.

In the case of using the liquid surface detecting device 101 for detecting the liquid surface of fuel containing alcohol, there would be caused such a problem that the metal from which the arm 120 is formed is corroded by the fuel, or the resin from which the float 122 is formed is swollen.

### BRIEF SUMMARY OF THE INVENTION

An object of the invention is to provide a liquid surface detecting device capable of solving the above-described problems.

In order to solve the above-described problems, according to a first aspect of the invention, there is provided a liquid surface detecting device having a movable unit having an arm and a float, for detecting a liquid surface, being based on a positional variation of the float, characterized in that a liquid-repellent coating is formed on a surface of at least one of the arm and the float.

According to a second aspect of the invention, there is provided a liquid surface detecting device having a movable unit provided with a float, for detecting a liquid surface, being based on a positional variation of the float, characterized in that the float includes a base formed of resin and a liquid-repellent coating formed on a surface of the base.

In the liquid surface detecting device according to the first or second aspect, the liquid-repellent coating may be formed of fluoroalkylsilane.

With the structure in the invention, since the liquid-repellent coating is formed on the surface of at least one of the arm and the float, a frictional resistance between a liquid and at least one of the arm and the float can be reduced, and accordingly, the float can be restrained from being displaced in response to a temporary displacement of the liquid surface as experienced in the conventional liquid surface detecting device, thereby it is possible to improve the degree of precision of detecting the liquid surface.

Since the float is prevented from being displaced in response to the temporary displacement of the liquid surface. It is possible to reduce abrasion of the contact parts of the electrode and the contact point.

Even though the liquid surface detecting device is used to detect the liquid surface of a fuel containing alcohol, it is possible to prevent the metal from which the base of the arm is made, from being corroded by the fuel in the case of the provision of the liquid-repellent coating on the surface of the arm. Moreover, it is possible to prevent the resin from which the base of the float is formed from being swollen by the fuel in the case of the provision of the liquid-repellent coating on the surface of the float.

Further, even though unevenness like burrs is present on the surfaces of the base of the arm and the float, according to the liquid-repellent coating formed on the surface of at least one of the arm and the float, the unevenness can be smoothed or moderated by the liquid-repellent coating. As a result, it is possible to reduce a resistance with respect to the liquid.

### BRIEF DESCRIPTION OF SEVERAL VIEWS OF DRAWING

FIG. 1 is a side view illustrating a liquid surface detecting device according to a first embodiment of the invention.

FIG. 2A is a vertical section view illustrating a float used in the first embodiment of the invention.

FIG. 2B is a sectional view illustrating the float taken along the line IIB-IIB shown in FIG. 2A.

FIG. 3 is a schematic view for explaining a gas phase method.

FIG. 4 is a side view illustrating a conventional liquid surface detecting device.

FIG. 5 is a partially enlarged view illustrating a substrate, a resistance layer, respective electrodes, a sliding ruler, and an arm in the conventional liquid surface detecting device.

### DETAILED DESCRIPTION OF THE INVENTION

A liquid surface detecting device according to the invention can be used to detect a liquid surface of a liquid such as a fuel in a container like a fuel tank. Hereinafter, in the following embodiments, explanation will be made of the liquid surface detecting device according to the invention which is incorporated in a liquid fuel tank of a vehicle.

### Embodiment 1

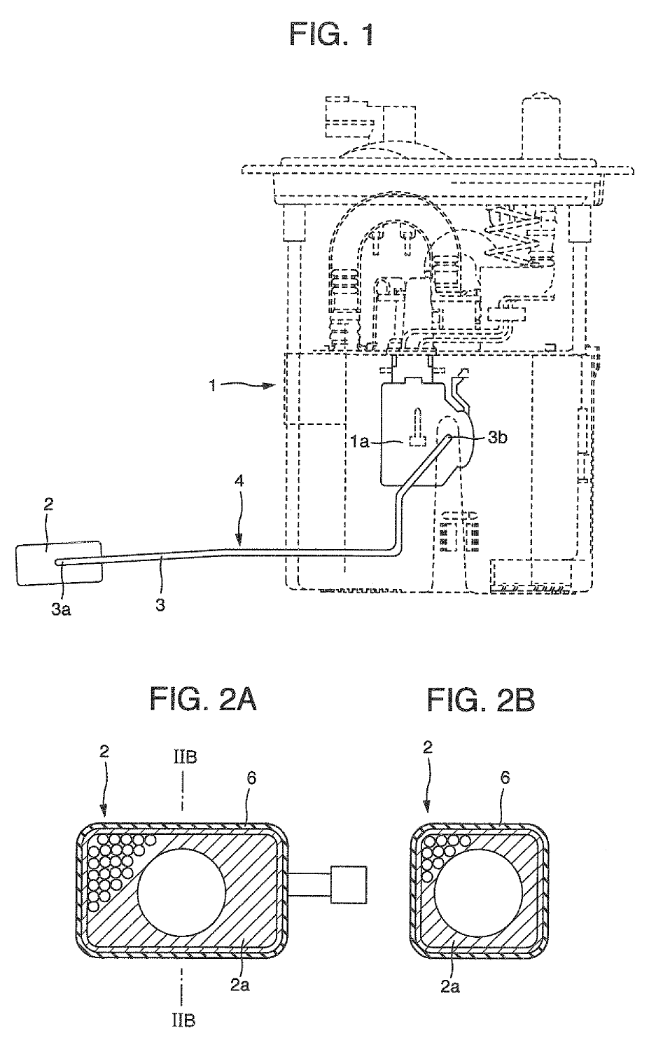

FIGS. 1 to 3 are views illustrating a first embodiment according to the invention.

FIG. 1 is a side view illustrating a liquid surface detecting device 1. The liquid surface detecting device 1 is incorporated in a liquid fuel tank of the vehicle, and is adapted to detect the liquid surface of the fuel in the fuel tank.

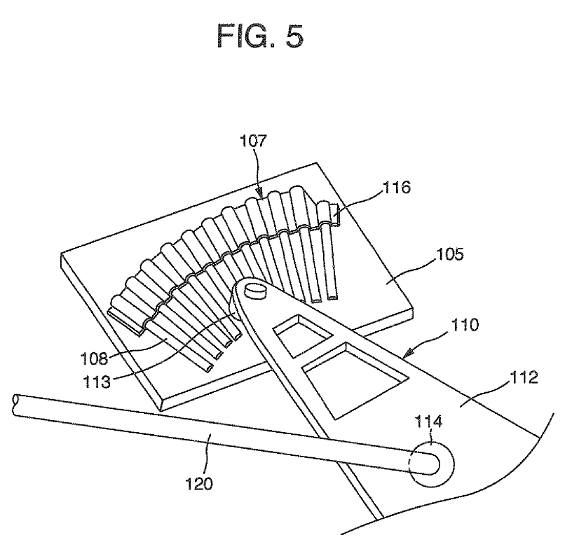

The liquid surface detecting device 1 includes the same members substantially as those of the conventional liquid surface detecting device 101 including a substrate 105, a resistance layer 107, a plurality of electrodes 108, and a sliding ruler 110 composed of a contact plate 112 and a contact point 113 as shown in FIG. 5. These members are disposed in a case la in FIG. 1 so as to performs the same functions as that of the conventional liquid surface detecting device. Since these members are the same as those of the known liquid surface detecting device, these members are omitted in FIG. 1 in order to prevent the depiction thereof from being complicated.

As shown in FIG. 1, the liquid surface detecting device 1 includes a float 2 and an arm 3, and the float 2, the arm 3 and the aforementioned sliding ruler (not shown) constitute a movable unit 4.

The float 2 is connected to one end portion 3a of the arm 3 so as to be relatively rotatable, and the other end portion 3b of the arm 3 is fixed to a rotation base of the contact plate in the same manner as that of the conventional liquid surface detecting device. Accordingly, the arm 3 is configured to rotate vertically about the rotation base which is the other end portion 3b, together with the contact plate.

A liquid-repellent coating is formed on outer surfaces of the float 2, the arm 3 and the sliding ruler in the movable unit 4. FIGS. 2A and 2B show a condition such that the liquid-repellent coating is formed on the outer surface of the float 2. The thickness of a liquid-repellent coating 6 is 1 μm or less. Should the thickness of the liquid-repellent coating 6 be not less than 1 μm, cracking would be caused in the liquid-repellent coating 6. Although the liquid-repellent coating 6 may be formed on the surface of the contact point of the sliding ruler, it is desirable not to form the liquid-repellent coating 6 thereon because the conductivity deteriorates.

In the embodiment, the liquid-repellent coating 6 formed of a material containing a fluoroalkylsilane (FAS) group material is used. A surface of the liquid-repellent coating 6 containing the fluoroalkylsilane group material has an extremely low surface energy, and has an excellent water-repellent property and an excellent oil-repellent property, that is, an excellent liquid-repellent property.

As the fluoroalkylsilane group material, for example, CF₃(CF)₈(CH₂)₂Si(OCH₃)₃ is used, but any material which can be strongly combined with a resin surface and a metal surface may be used. Specifically, as X (functional group) in Chemical Formula 1, fluoroalkylsilane having a functional group such as alkoxide or chlorine is particularly suitable. The longer the fluoroalkylsilane chain is, the better the liquid-repellent performance is, and the shorter the fluoroalkylsilane chain is, the worse the liquid-repellent performance is. Further, there may be used partial hydrolysate of fluoroalkylsilane or a compound thereof.

CF₃(CF₂)ₙ(CH₂)₂SiX₃ (Chemical Formula 1)

where n denotes an integer from 1 to 15 and X denotes a functional group such as alkoxide or chlorine.

Next, a method of forming the liquid-repellent coating 6 will be described.

At first, a method of forming the liquid-repellent coating 6 on the surface of the float 2 shown in FIGS. 2A and 2B will be described.

The base 2a of the float 2 is formed of resin, having a predetermined shape. As the resin, for example, polyacetal resin or NBR rubber foam may be used.

As the method of forming the liquid-repellent coating 6 on the surface of the base 2a, a liquid phase method and a gas phase method are used, which can be arbitrarily selected based on the material of the base 2a. For example, if the base 2a is formed of polyacetal resin, the liquid phase method or the gas phase method may be used. Alternatively, when the base 2a is formed of NBR rubber foam, the gas phase method is used.

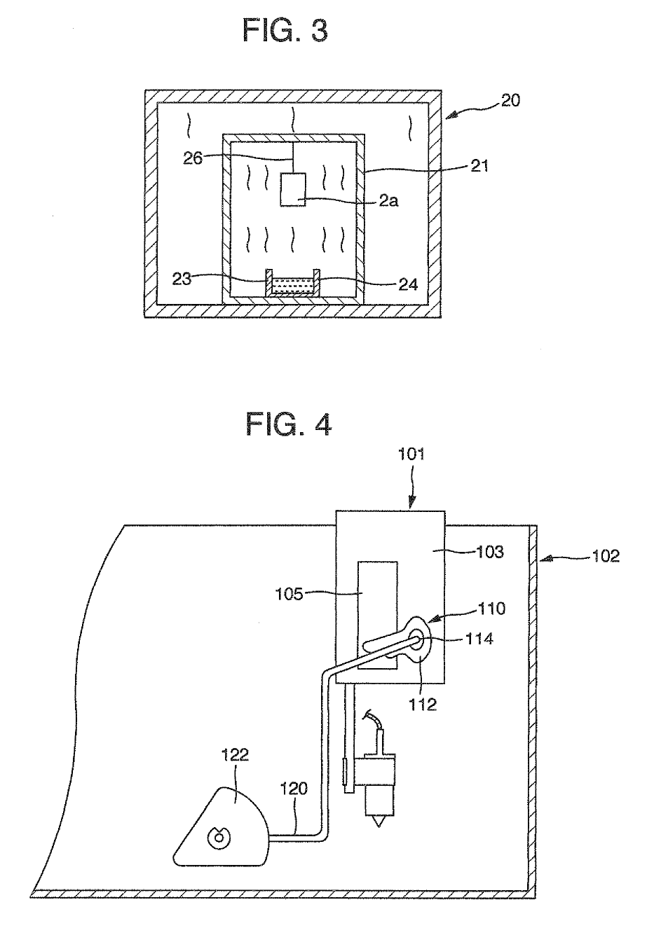

The gas phase method (chemical vapor deposition) will be described with reference to FIG. 3 as an example.

A treatment container 21 is disposed in a thermoregulator 20, and a Petri dish 24 in which a liquid of fluoroalkylsilane 23 is injected is placed on the bottom of the treatment container 21. Within the treatment container 21, the base 2a of the float 2 is located above the Petri dish 24, being suspended by a support member 26 from the ceiling of the treatment container 21. A pretreatment such as degreasing and cleaning is performed for the base 2a.

The inside of the thermoregulator 20 has been heated at a temperature in a range from 80° C. to 120° C. In addition, an air in the treatment container 21 is exhausted by a vacuum pump (not shown), and thus, the inside of the treatment container 21 has been maintained at a predetermined vacuum state. Accordingly, fluoroalkylsilane evaporates from the Petri dish 24 and floats in the treatment container 21. The gas of fluoroalkylsilane is combined with the surface of the base 2a so as to form the liquid-repellent coating 6.

Next, an example of the liquid phase method will be described.

After the base 2a of the float 2 is degreased and cleaned, the base 2a is dipped in a coating solution listed in Table 1 or a coating solution is sprayed onto the base 2a so as to allow the coating solution to stick to the surface of the base 2a.

TABLE 1

| Composition Liquid | Molar Ratio |
|---|---|
| Methyltetraethoxysilane | 1 |
| n-butanol | 7 |
| Distilled Water | 7 |
| Phosphoric Acid | 5 |
| Ethanol | 0.05 |
| Fluoroalkylsilane | 0.1 |

Subsequently, the remaining coating solution is removed from the base 2a by use of an air blow or centrifugal separation.

Subsequently, the base 2a is dried, and baked at a temperature in a range from 120° C. to 180° C. so as to form the liquid-repellent coating 6 on the base 2a.

It is noted that the liquid-repellent coating 6 may be formed on the surface of the metal base in the movable unit 4, such as the base of the arm 3 other than the float 2 by use of the liquid phase method or the gas phase method.

In the liquid surface detecting device 1 having the above-described configuration, it is possible to detect the liquid surface in the tank in the same manner as that of the conventional liquid surface detecting device 101.

Since the liquid surface detecting device 1 according to the first embodiment of the invention has the above-described configuration, the following technical effect and advantage can be exhibited Since the liquid-repellent coating 6 is formed on the surface of the movable unit 4, a frictional resistance between the movable unit 4 and the liquid such as fuel is reduced. Since it is difficult for the float 2 to displace in response to a temporary displacement of the liquid surface, in comparison with the conventional liquid surface detecting device 101, it is possible to improve degree of precision of detecting the liquid surface.

Since it is difficult for the float 2 to displace in response to temporary displacement of the liquid surface, it is possible to reduce abrasion of the contact portions of both electrode and contact point.

Even when the liquid surface detecting device is used to detect the liquid surface of a fuel containing alcohol, it is possible to prevent the metal from which the base of the arm 3 is made, from being corroded by the fuel. Moreover, it is possible to prevent the resin from which the base 2a of the float 2 is made, from being swollen.

Further, even though unevenness, for example, burrs of the float formed of resin are present on the surface of the arm 3 or the base 2a of the float 2, it is possible to smooth or moderate the unevenness according to the provision of the liquid-repellent coating 6, and thus it is possible to reduce a resistance with respect to the liquid.

### Embodiment 2

In the embodiment 1, although the liquid-repellent coating 6 is formed on the whole surface of the movable unit 4, the liquid-repellent coating 6 may be formed on at least one of the float 2 and the arm 3.

The other configuration is the same as that in the embodiment 1. Even in the second embodiment, the same advantage and effect as those of the embodiment 1 can be exhibited.

1. A liquid surface detecting device comprising a movable unit having an arm and a float, for detecting a liquid surface, in response to a positional variation of the float,
wherein a liquid-repellent coating is formed on a surface of at least one of said arm and said float.

2. A liquid surface detecting device comprising a movable unit having a float, for detecting a liquid surface in response to a positional variation of the float,
wherein said float includes a base formed of resin and a liquid-repellent coating formed on a surface of said base.

3. The liquid surface detecting device according to claim 1, wherein the liquid-repellent coating is formed of fluoroalkylsilane.

4. The liquid surface detecting device according to claim 2, wherein the liquid-repellent coating is formed of fluoroalkylsilane.
